(19) United States
(12) Patent Application Publication
(10) Pub. No.: US 2017/0369339 A1
(43) Pub. Date: Dec. 28, 2017

(54) APPARATUSES AND METHODS TO PROVIDE ELECTROLYZED FLUID

(71) Applicant: OSAKA ELECTRO-COMMUNICATION UNIVERSITY, Osaka (JP)

(72) Inventors: Koichi Umimoto, Kobe-shi (JP); Shunji Nagata, Nara-shi (JP); Aki Kamada, Osaka (JP)

(73) Assignee: OSAKA ELECTRO-COMMUNICATION UNIVERSITY, Osaka (JP)

(21) Appl. No.: 15/189,297

(22) Filed: Jun. 22, 2016

(51) Int. Cl. C02F 1/461; C02F 103/02

(52) U.S. Cl. CPC C02F 1/4618; C02F 1/46176; C02F 2201/46115; C02F 2001/46171; C02F 2001/46161; C02F 2303/04; C02F 2103/02

(57) ABSTRACT

Technologies are generally described for an apparatus configured to process a volume of a fluid and provide an electrolyzed fluid. Example apparatuses described herein may include a base cell, electrodes and/or a variable expansion cell. The base cell may be configured to contain at least a portion of the volume of the fluid. Electrodes may include an anode and a cathode. The electrodes may be configured to be mounted within the base cell. The variable expansion cell may be coupled to the base cell, and adjustably configured to change a volumetric space of the apparatus to accommodate the volume of the fluid such that the electrodes are substantially immersed in the fluid.

### BACKGROUND

Unless otherwise indicated herein, the approaches described in this section are not prior art to the claims in this application and are not admitted to be prior art by inclusion in this section.

Typically, electrolyzed fluid has been used at, for example, medical facilities such as hospitals, welfare and care facilities, nursery school, food processing factories, hotels, restaurants, eateries, or any facilities required to be sterilized. For example, electrolyzed fluid may be used for sterilization, purification, and/or deodorization in such facilities.

Recently, as interests in use of the electrolyzed fluid have been increased, various demands for the electrolyzed fluid have also arisen. Electrolyzed fluid may be used to sterilize food that should not be heated. For example, the electrolyzed fluid is used to sterilize vegetables, fruits and fish to prevent food poisoning involving, such as, for example, norovirus, O-157, staphylococcus aureus, bacillus cereus, etc. Further, the electrolyzed fluid may be used to sterilize cooking instruments, such as kitchen knives, cutting boards, dish towels, etc. The electrolyzed fluid may also be used to prevent infection of human or animal bodies, instead of using alcohol. That is, the demands for the electrolyzed fluid are increasing for domestic use as well as industrial use.

### SUMMARY

Technologies generally described herein relate to providing an electrolyzed fluid.

Various example apparatuses configured to process a volume of a fluid and provide an electrolyzed fluid, as described herein, may include a base cell, electrodes and/or a variable expansion cell. The base cell may be configured to contain at least a portion of the volume of the fluid. The electrodes may include an anode and a cathode. The electrodes may be configured to be mounted within the base cell. The variable expansion cell may be coupled to the base cell. The variable expansion cell may be adjustably configured to change a volumetric space of the apparatuses to accommodate the volume of the fluid such that the electrodes are substantially immersed in the fluid.

In some examples, an apparatus configured to process a volume of a fluid and provide an electrolyzed fluid is described herein. The example apparatus may include a base cell, a membrane, an anode, a cathode, an anode expansion cell and/or a cathode expansion cell. The base cell may be configured to contain at least a portion of the fluid. The membrane may be configured to divide the base cell into an anode portion and a cathode portion. The anode may be mounted within the anode portion of the base cell. The cathode may be mounted within the cathode portion of the base cell. The anode expansion cell may be variably configured to provide a first additional space. The first additional space may be coupled to the anode portion of the base cell such that a capacity of the first additional space is adjustable. The cathode expansion cell may be variably configured to provide a second additional space. The second additional space may be coupled to the cathode portion of the base cell such that a capacity of the second additional space is adjustable.

In some examples, a method to process a volume of a fluid and provide an electrolyzed fluid is described herein. The example method may include changing a volumetric space of an apparatus. The apparatus may be configured to contain the fluid and include electrodes. The volumetric space is adjustable and configured to accommodate the volume of the fluid such that the electrodes are substantially immersed in the fluid. Then, the example method may include electrically conducting the fluid via the electrodes to provide the electrolyzed fluid.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows a block diagram of an example apparatus configured to process a volume of a fluid and provide an electrolyzed fluid;

FIG. 2 schematically shows a block diagram of another example apparatus configured to process a volume of a fluid and provide an electrolyzed fluid;

FIG. 3 schematically shows a side-sectional view of an example apparatus configured to process a volume of a fluid and provide an electrolyzed fluid;

FIG. 4 schematically shows a side-sectional view of another apparatus configured to process a volume of a fluid and provide an electrolyzed fluid;

FIGS. 5A and 5B illustrate graphs showing changes in a pH level and an AC (available chlorine) concentration of a fluid as an example apparatus has electrolyzed the fluid, where a volumetric space of the example apparatus is set symmetrically;

FIGS. 6A and 6B illustrate graphs showing changes in a pH level and an AC concentration of a fluid as another example apparatus has electrolyzed the fluid, where a volumetric space of the other example apparatus is set asymmetrically; and

FIG. 7 schematically shows an example flow of a method to process a volume of a fluid and provide an electrolyzed fluid,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems and devices related to provide an electrolyzed fluid.

Briefly stated, technologies are generally described for an apparatus to process a volume of a fluid and provide an electrolyzed fluid. Example apparatuses described herein may include a base cell, electrodes and/or a variable expansion cell. The base cell may be configured to contain at least a portion of the volume of the fluid. The electrodes may include an anode and a cathode that may be mounted within the base cell. The variable expansion cell may be coupled to the base cell and variably configured to provide additional space to accommodate the volume of the fluid. The additional space of the variable expansion cell may be adjustable. The electrodes may be substantially immersed in the fluid contained in the base cell. That is, the volumetric amount of the apparatus may be adjustable depending on a required amount of the electrolyzed fluid, while the electrodes are substantially immersed in the fluid.

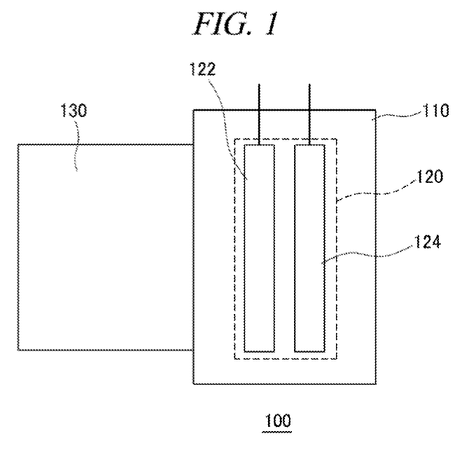

FIG. 1 schematically shows a block diagram of an example apparatus configured to process a volume of a fluid and provide an electrolyzed fluid, arranged in accordance with at least some embodiments described herein. As depicted, an apparatus 100 may include one or more of a base cell 110, electrodes 120 and/or a variable expansion cell 130. Apparatus 100 may be configured to contain a volume of a fluid. In some embodiments, base cell 110 of apparatus 100 may be configured to contain at least a portion of the volume of the fluid. In an example, the fluid may include, but not be limited to, a water in which electrolyte is dissolved to facilitate electrolysis, such as, for example, saline solution. In another example, the fluid may include other solutions which includes other chlorides (such as alkali metal chlorides, other metal chlorides), other halides, etc. In some examples, the fluid whose concentration of the electrolyte is within the allowable range by the local regulations, may be used, but the range of its concentration is not limited thereto.

In some embodiments, base cell 110 may include at least one fluid inlet (not shown) formed on a surface of base cell 110. The fluid can be input into base cell 110 through the at least one fluid inlet. In an example, the fluid inlet may be formed on, for example, upper surface of base cell 110, but the formed position of the fluid inlet is not limited thereto.

In some embodiments, base cell 110 may include at least one fluid outlet (not shown). The at least one fluid outlet may be configured to provide the electrolyzed fluid from apparatus 100. In some examples, the at least one fluid outlet may be formed on a surface of base cell 110. In an example, the fluid outlet may be formed on a surface of base cell 110 that is different from the formed position of the fluid inlet, such as, for example, a bottom surface of base cell 110. By way of example, but not limitation, the at least one fluid outlet may include a valve to adjust an output amount of the electrolyzed fluid.

Electrodes 120 may be configured to be mounted within base cell 110. In some examples, base cell 110 may have at least one mounting element to hold electrodes 120. Electrodes 120 may include an anode 122 and a cathode 124. Various types of electrodes 120 may be available. For example, but not limitation, electrodes 120 may include one or more of mesh-type electrodes, plate-type electrodes and/or rod-type electrodes. Further, various materials may be used as anode 122 and cathode 124 of electrodes 120. In an example that saline solution is used as the fluid, platinum-coated titanium may be used as anode 122 to cause anode 122 not to chemically react with chlorine ions. In another example, anode 122 may include graphite. In some examples, electrodes 120 may be configured to be immersed in the fluid when electrodes 120 are mounted within base cell 110 and at least a portion of the fluid is contained in base cell 110.

In an example, base cell 110 may include a parallelepiped-type cell, where a flat-shaped membrane (not shown) may be used in base cell 110 to divide base cell 110 into an anode portion and a cathode portion. Anode 122 may be mounted within the anode portion and cathode 124 may be mounted within the cathode portion. In another example, base cell 110 may include a parallelepiped-type cell without membrane, such as using non-diaphragm techniques, magnetic wall techniques, etc. In both examples, base cell 110 may be divided into the anode portion disposed on one side of base cell 110 and the cathode portion disposed on another side of base cell 110. In some other examples, base cell 110 may include a cylindrical-type cell, where a cylindrical-shaped membrane may be used in base cell 110 to divide base cell 110 into an anode portion disposed on inner/outer side of base cell 110 and a cathode portion disposed on outer/inner side of base cell 110.

In some embodiments, variable expansion cell 130 may be coupled to base cell 110. In some examples, variable expansion cell 130 may be fluidically coupled to base cell 110, and when the fluid is provided to base cell 110, a portion of the fluid may flow into the variable expansion cell 130 through base cell 110. In such manners, variable expansion cell 130 may provide additional volumetric space of apparatus 100 to accommodate the volume of the fluid. That is, while base cell 110 is containing at least a portion of the volume of the fluid, variable expansion cell 130 may accommodate the remaining portion of the volume of the fluid.

Variable expansion cell 130 may be adjustably configured to change the volumetric space of apparatus 100. In some examples, variable expansion cell 130 may include a volumetric space adjustor (not shown) configured to variably adjust a volumetric space of apparatus 100 (more particularly, a volumetric space of variable expansion cell 130). The volumetric space of apparatus 100 may be adjusted by using the volumetric space adjustor. By way of example, but not limitation, the volumetric space adjustor may include one or more of a piston-type of pump and/or a plunger-type of pump, and the volumetric space of apparatus 100 may be adjusted by changing the position of the one or more of a piston-type of pump and/or a plunger-type of pump. As such, the volumetric space of apparatus 100 may be variably adjusted as needed. Various volumetric shapes of variable expansion cell 130 may be available. By way of example, but not limitation, variable expansion cell 130 may include a cylindrical cell, spherical cell, polyhedral cell, etc., or combinations thereof.

In some embodiments, variable expansion cell 130 may be coupled to base cell 110 and adjustably configured to change a volumetric space of apparatus 100 to accommodate the volume of the fluid such that electrodes 120 are substantially immersed in the fluid. In an example, variable expansion cell 130 may be disposed such that a top surface of variable expansion cell 130 is positioned lower than a top surface of base cell 100, so that the electrodes are readily immersed in the fluid. Since electrodes 120 in base cell 110 are substantially immersed in sufficient amount of the fluid, electrolysis in apparatus 100 can be effectively performed in terms of time and/or power.

In some examples, base cell 110 and/or variable expansion cell 130 may be operably configured to be able to contain an acidic-electrolyzed fluid and/or an alkaline-electrolyzed fluid. Base cell 110 and/or variable expansion cell 130 may be made of materials that do not to chemically react with such an acidic and/or alkaline fluid electrolyzed from the fluid. By way of example, but not limitation, the materials of base cell 110 and/or variable expansion cell 130 may include at least one of stainless steel, resin materials such as, acrylic resin, etc.

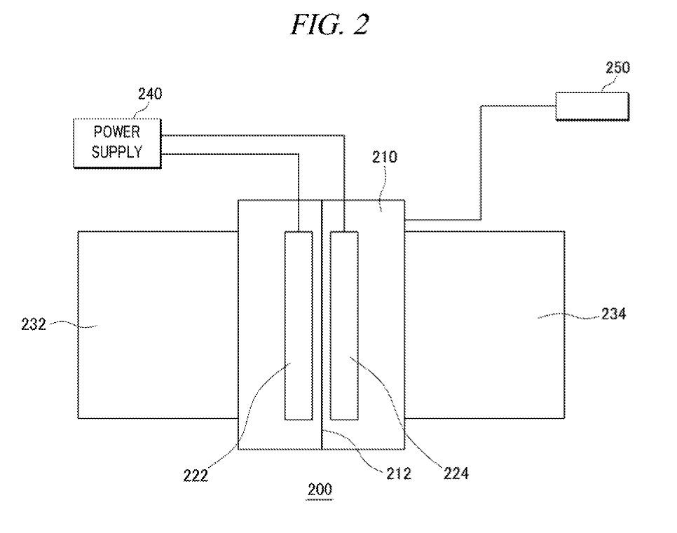

FIG. 2 schematically shows a block diagram of another example apparatus configured to process a volume of a fluid and provide an electrolyzed fluid, arranged in accordance with at least some embodiments described herein. As depicted, an apparatus 200 may include one or more of a base cell 210, a membrane 212, an anode 222, a cathode 224, an anode expansion cell 232 and/or a cathode expansion cell 234. Apparatus 200 may be configured to contain a volume of a fluid. In some embodiments, base cell 210 may be configured to contain at least a portion of the volume of the fluid, as described with regard to base cell 110 shown in FIG. 1.

In some embodiments, membrane 212 may be configured to divide base cell 210 into an anode portion and a cathode portion. When electrolysis is carried out in apparatus 200, membrane 212 may enable apparatus 200 to obtain, from the fluid, an acidic-electrolyzed fluid in the anode portion and an alkaline-electrolyzed fluid in the cathode portion. In some examples where the fluid includes chloride ions as in the saline solution, the membrane may be configured to prevent decreasing available chlorine (AC) concentration of an acidic-electrolyzed fluid during or after electrolysis is carried out in apparatus 200. In some examples, membrane 212 may include, for example, at least one of a porous membrane, such as a ceramic film or plate by a biscuit firing, or an ion-exchange membrane to exchange, for example, cations. In some other examples, apparatus 200 may be configured to use, for example, non-diaphragm techniques, magnetic wall techniques, etc. to omit membrane 212.

In some embodiments, base cell 210 may include at least one fluid inlet (not shown) formed on a surface of base cell 210, and the fluid can be provided to base cell 210 through the at least one fluid inlet. By way of example, but not limitation, the at least one fluid inlet may be provided on a top surface of base cell 210 so that the fluid can easily flow into base cell 210.

In some embodiments, base cell 210 may include at least one fluid outlet, and the at least one fluid outlet may be configured to provide the electrolyzed fluid from apparatus 200. By way of example, but not limitation, the at least one fluid outlet may be provided on a bottom surface of base cell 210 so that the fluid can easily flow out of base cell 210. Further, the at least one fluid outlet may include a valve to adjust an output amount of the electrolyzed fluid. In an example, two fluid outlets may be formed on a surface of base cell 110, where one of the two fluid outlets may be formed on the anode portion and another of the two fluid outlets may be formed on the cathode portion.

In some embodiments, anode 222 may be configured to be mounted within the anode portion of base cell 210 and cathode 224 may be configured to be mounted within the cathode portion of base cell 210. In some examples, base cell 110 may have at least one mounting element to hold anode 222 and cathode 224 in the anode and cathode portions, respectively. Various types of anode 222 and cathode 224 may be available. For example, but not limitation, anode 222 and cathode 224 may include one or more of mesh-type electrodes, plate-type electrodes and/or rod-type electrodes. In an example that saline solution is used as the fluid, platinum-coated titanium may be used as anode 222 to cause anode 222 not to chemically react with chlorine ions. In another example, anode 122 may include graphite. When anode 222 and cathode 224 are mounted within the anode and the cathode portions and the at least portion of the fluid is contained in base cell 210, both of anode 222 and cathode 224 may be immersed in the fluid.

In some embodiments, anode expansion cell 232 and cathode expansion cell 234 may be coupled to base cell 210. In some examples, anode and cathode expansion cells 232 and 234 may be fluidically coupled to base cell 210, and when the fluid is provided to base cell 110, each of anode and cathode expansion cells 232 and 234 may receive a portion of the fluid through base cell 210. In such manners, each of anode and cathode expansion cells 232 and 234 may provide an additional volumetric space of apparatus 200 to accommodate the volume of the fluid.

In some embodiments, anode expansion cell 232 may be variably configured to provide a first additional space to accommodate a portion of the volume of the fluid such that a capacity of the first additional space may be adjustable. The first additional space may be coupled to the anode portion of base cell 210. Similarly, cathode expansion cell 234 may be variably configured to provide a second additional space to accommodate a portion of the volume of the fluid such that a capacity of the second additional space may be adjustable. The second additional space may be coupled to the cathode portion of base cell 210. In some examples, during or after electrolysis is carried out in apparatus 200, anode expansion cell 232 and cathode expansion cell 234 may be configured to contain an acidic-electrolyzed fluid and an alkaline-electrolyzed fluid, respectively, obtained from the fluid.

In some embodiments, apparatus 200 may further include a first volumetric space adjustor (not shown) and a second volumetric space adjuster (not shown). The first volumetric space adjustor may be coupled to anode expansion cell 232 and configured to variably adjust the capacity of the first additional space. Similarly, the second volumetric space adjustor may be coupled to cathode expansion cell 234 and configured to variably adjust the capacity of the second additional space. By way of example, but not limitation, the first and second volumetric space adjustors may include one or more of a piston-type of pump and/or a plunger-type of pump, and the first and second additional spaces may be adjusted by changing the position of the one or more of a piston-type of pump and/or a plunger-type of pump. In some examples, the capacities of the first and second additional space are independently adjustable. As such, the volumetric space of apparatus 200 may be variably adjusted as needed. Various volumetric shapes of anode and cathode expansion cells 232 and 234 may be available. By way of example, but not limitation, anode and cathode expansion cells 232 and 234 may include a cylindrical cell, spherical cell, polyhedral cell, etc., or combinations thereof.

In some examples, base cell 210, anode expansion cell 232 and/or cathode expansion cell 234 may be operably configured to be able to contain an acidic-electrolyzed fluid and/or an alkaline-electrolyzed fluid. Base cell 210, anode expansion cell 232 and/or cathode expansion cell 234 may be made of materials that do not chemically react with an acidic fluid and an alkaline fluid electrolyzed from the fluid. By way of example, but not limitation, the materials of base cell 210, anode expansion cell 232 and/or cathode expansion cell 234 may include at least one of stainless steel, resin materials such as, acrylic resin, etc.

Optionally, apparatus 200 may further include one or more fluid circulation means (not shown). In some embodiments, the one or more fluid circulation means may be coupled to base cell 210 or anode and cathode expansion cells 232 and 234 and configured to circulate between the fluid in base cell 210 and the fluid in anode and cathode expansion cells 232 and 234. By way of example, but not limitation, the one or more fluid circulation means may use a stir bar, such as a magnetic stir bar.

Additionally, apparatus 200 may further include a power supply 240. Power supply 240 may be coupled to both of anode 222 and cathode 224 and configured to effect electrical conduction through the fluid via anode 222 and cathode 224. In some examples, power supply 240 may provide a direct current to electrolyze the fluid.

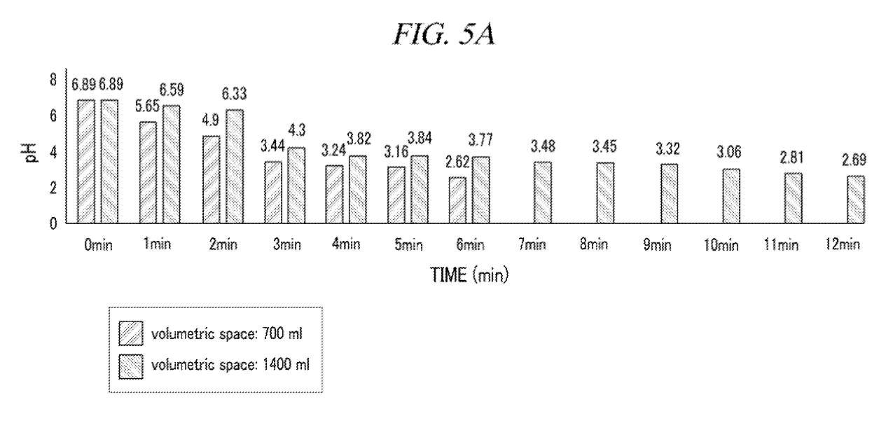

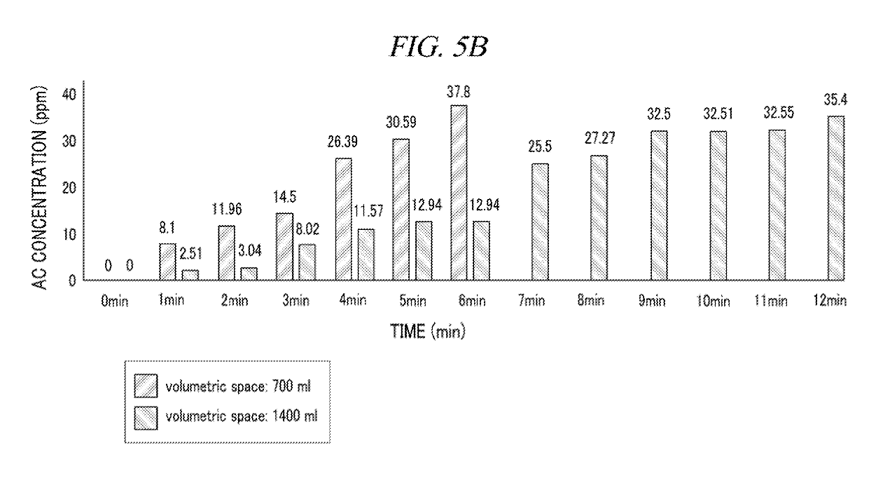

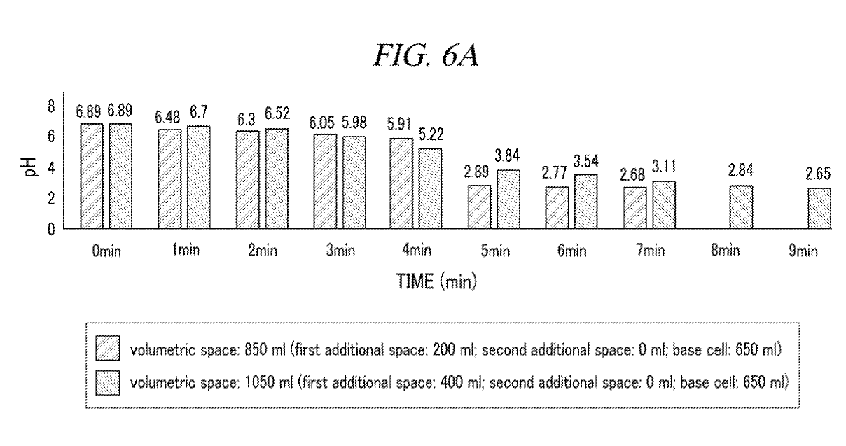

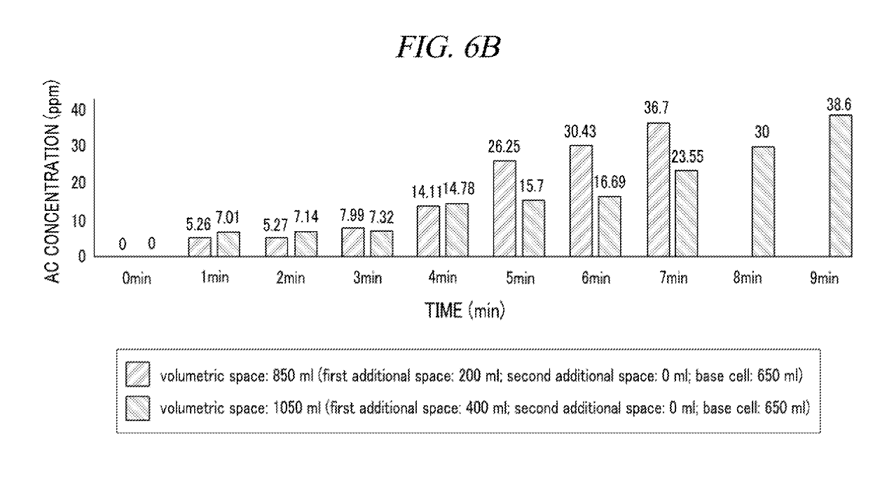

Further, apparatus 200 may include measuring device 250 operably coupled to base cell 210. In some examples, measuring device 250 may include, for example, a pH meter. As will be described in more details with regard to FIGS. 5A and 6A, the pH meter may be configured to measure a pH level associated with the fluid. Additionally or alternatively, measuring device 250 may include, for example, a sterilizing meter. The sterilizing meter may be operably coupled to the anode portion of base cell 210 and. As will be described in more details with regard to FIGS. 5B and 6B, the sterilizing meter may be configured to measure an available chlorine (AC) concentration associated with the fluid.

Furthermore, apparatus 200 may include a controller (not shown). In some examples, the controller may be coupled to at least one of the first volumetric space adjustor and the second volumetric space adjuster, and configured to automatically control the at least one of the first volumetric space adjustor and second volumetric space adjustor to obtain the desired capacities of the corresponding additional spaces. Additionally or alternatively, the controller may be coupled to power supply 240 and configured to automatically control power supply 240 to provide a direct current with desired voltage and/or time.

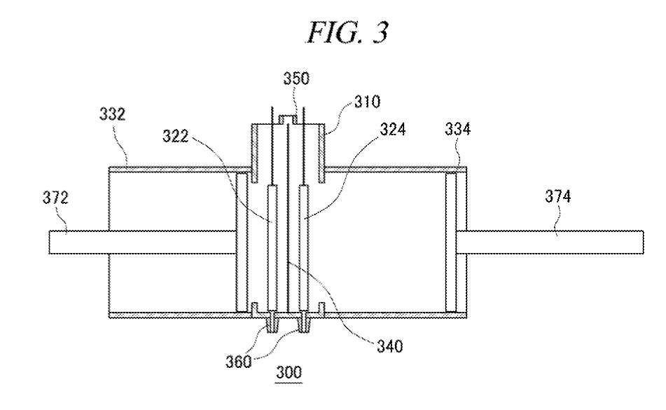

FIG. 3 schematically shows a side-sectional view of an example apparatus configured to process a volume of a fluid and provide an electrolyzed fluid, arranged in accordance with at least some embodiments described herein. As depicted, an apparatus 300 may include a base cell 310, an anode 322, a cathode 324, an anode expansion cell 332 and a cathode expansion cell 334, a membrane 340, a fluid inlet 350, two fluid outlets 360 and piston-type of pumps 372 and 374. As described in the above with regard to FIGS. 1 and 2, anode 322 and cathode 324 may be mounted within base cell 310. In some examples, anode 322 and cathode 324 may be coupled to a power supply (not shown). Anode expansion cell 332 and cathode expansion cell 334 may be coupled to base cell 310 and provide additional volumetric spaces to accommodate at least a portion of the volume of the fluid. Each of the additional volumetric spaces of anode and cathode expansion cells 332 and 334 may be adjusted by changing the position of piston-type of pumps 372 and 374. For example, as depicted with regard to anode expansion cell 332 and piston-type of pump 372, the closer, piston-type of pump 372 is moved to base cell 310, the smaller, an additional volumetric space of anode expansion cell 332 is obtained. Further, as depicted with regard to cathode expansion cell 334 and piston-type of pump 374, the farther, piston-type of pump 374 is moved from base cell 310, the larger, an additional volumetric space of cathode expansion cell 334 is obtained.

As depicted, fluid inlet 350 may be formed on a surface of base cell 310. In some examples, the fluid may be provided to base cell 310 through fluid inlet 350, and base cell 310 may contain at least a portion of the volume of the fluid, while anode and cathode expansion cells 332 and 334 are configured to contain the remaining portion of the volume of the fluid. Electrodes 322 and 324 may be substantially immersed in the fluid.

As depicted, membrane 340 may be disposed within base cell 310. Membrane 340 may be configured to divide base cell into an anode portion and a cathode portion, and anode 322 and cathode 324 may be disposed in the anode portion and the cathode portion, respectively. During or after electrolysis, an acidic-electrolyzed fluid and an alkaline-electrolyzed fluid may be collected in the anode and cathode portions, respectively.

As depicted, two fluid outlets 360 may be formed on a surface of base cell 310, such as, for example, a bottom surface of base cell 210. Fluid outlets 360 formed on the anode portion may provide acidic-electrolyzed fluid and fluid outlets 360 formed on the cathode portion may provide alkaline-electrolyzed fluid. Although it is not shown in FIG. 3, fluid outlets 360 may include a valve to adjust an output amount of the electrolyzed fluid.

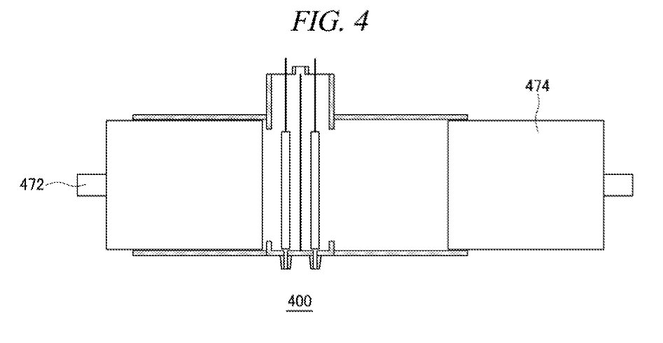

FIG. 4 schematically shows a side-sectional view of another apparatus configured to process a volume of a fluid and provide an electrolyzed fluid, arranged in accordance with at least some embodiments described herein. As depicted, apparatus 400 may include plunger-type of pumps 472 and 474, while the other components are similar to apparatus 300 shown in FIG. 3.

### EXAMPLES

The present disclosure will be understood more readily by reference to the following examples, which are provided by way of illustration and are not intended to be limiting in any way.

### Example 1: Using an Example Apparatus to Measure a pH Level and an AC Concentration

In one experimental example, pH levels and AC concentrations of a fluid were measured by using an example apparatus manufactured according to the above embodiments. FIGS. 5A and 5B illustrate graphs showing changes in a pH level and an AC (available chlorine) concentration of a fluid as an example apparatus has electrolyzed the fluid, where a volumetric space of the example apparatus is set symmetrically, arranged in accordance with at least some embodiments described herein.

In this example, the apparatus was implemented according to the configuration as illustrated in at least one of FIGS. 1-4. That is, the apparatus was implemented such that the apparatus includes a base cell, an anode expansion cell and a cathode expansion cell; the anode and cathode expansion cells are configured to provide first and second additional spaces, respectively; and the first and second additional spaces are independently adjustable. The minimum volumetric space of the apparatus was implemented to be 700 ml and the maximum volumetric space of the apparatus was implemented to be 1400 ml. Further, 0.1% NaCl solution was provided to the apparatus as the fluid.

In this example, the volumetric space of the apparatus was set symmetrically. Specifically, the volumetric capacities of the first and second additional spaces were set to be substantially same each other. In a first experiment, the volumetric space of the apparatus was set minimally (i.e., to be 700 ml). In a second experiment, the volumetric space of the apparatus was set maximally (i.e., to be 1400 ml). During electrolysis in the apparatus, the pH levels and the AC concentrations of the fluid contained within the apparatus (i.e., an anode portion in which an anode is disposed in the base cell) were measured at every minute. Further, the experiments according to this example were performed until the AC concentrations of the fluid reach within the range of 35 ppm to 40 ppm. Thus, as depicted in FIGS. 5A and 5B, the first experiment, where the volumetric space of the apparatus was symmetrically set to be 700 ml, was finished after measuring at the sixth minute and the second experiment where the volumetric space of the apparatus was symmetrically set to be 1400 ml was finished after measuring at twelfth minute.

As shown in FIGS. 5A and 5B, left bars at each minute illustrate the results of electrolysis in accordance with the first experiment and right bars at each minute illustrate the results of electrolysis in accordance with the second experiment. It can be noted that, as shown in the results measured at the first and second minutes, an electrolyzed fluid from about pH 5.0 to 6.5 may be typically referred to as a slightly-acidic fluid, and as shown in the result of the left bar measured at the sixth minute and the result of the right bar measured at the twelfth minute, the electrolyzed fluid from about pH 2.2 to 2.7 may be typically referred to as a strongly-acidic fluid.

### Example 2: Using Another Example Apparatus to Measure a pH Level and an AC Concentration

In another experimental example, pH levels and AC concentrations of a fluid were measured by using another example apparatus manufactured according to the above embodiments. FIGS. 6A and 6B illustrate graphs showing changes in a pH level and an AC concentration of a fluid as another example apparatus has electrolyzed the fluid, where a volumetric space of the another example apparatus is set asymmetrically, arranged in accordance with at least some embodiments described herein.

In this example, the apparatus was implemented according to the configuration as illustrated in at least one of FIGS. 1-4. That is, the apparatus was implemented such that the apparatus includes a base cell, an anode expansion cell and a cathode expansion cell; the anode and cathode expansion cells are configured to provide first and second additional spaces, respectively; and the first and second additional spaces are independently adjustable. The volumetric space of the base cell was implemented to be 650 ml, while the minimum and maximum volumetric spaces of the first and second additional spaces were implemented to be 0 ml and 400 ml, respectively. Further, 0.1% NaCl solution was provided to the apparatus as the fluid.

In this example, the volumetric space of the apparatus is set asymmetrically. Specifically, the volumetric capacity of the second additional space was set minimally (i.e., to 0 ml). In a third experiment, the volumetric space of the first additional space was set to 200 ml, such that the total volumetric space of the apparatus is 850 ml. In a fourth experiment, the volumetric space of the first additional space was set to 400 ml, such that the total volumetric space of the apparatus is 1050 ml. During electrolysis in the apparatus, the pH levels and the AC concentrations of the fluid contained within the apparatus (i.e., an anode portion in which an anode is disposed) were measured at every minute. Further, the experiments according to this example were also performed until the AC concentrations of the fluid reach within the range of 35 ppm to 40 ppm. Thus, as depicted in FIGS. 6A and 6B, the third experiment, where the volumetric space of the apparatus was asymmetrically set to be 850 ml, was finished after measuring at the seventh minute and the second experiment, where the volumetric space of the apparatus was asymmetrically set to be 1050 ml, was finished after measuring at ninth minute.

As shown in FIGS. 6A and 6B, left bars at each minute illustrate the results of electrolysis in accordance with the third experiment and right bars at each minute illustrate the results of electrolysis in accordance with the fourth experiment. It can be noted that, as shown in the results measured at the first to fourth minutes, an electrolyzed fluid from about pH 5.0 to 6.5 may be typically referred to as a slightly-acidic fluid, and as shown in the result of the left bar measured at the seventh minute and the result of the right bar measured at the ninth minute, the electrolyzed fluid from about pH 2.2 to 2.7 may be typically referred to as a strongly-acidic fluid.

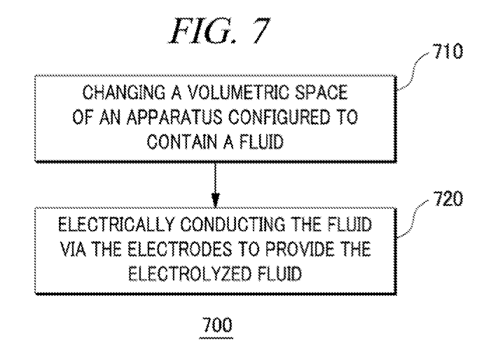

FIG. 7 schematically shows an example flow of a method to process a volume of a fluid and provide an electrolyzed fluid, arranged in accordance with at least some embodiments described herein.

Method 700 may be implemented using, for example, an apparatus, as described with regard to FIGS. 1-4. Method 700 may include one or more operations, actions, or functions as illustrated by blocks 710 and/or 720. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof. Method 700 may begin at block 710, “CHANGING A VOLUMETRIC SPACE OF AN APPARATUS CONFIGURED TO CONTAIN A FLUID.”

At block 710, the apparatus (e.g., variable expansion cell 130 shown in FIG. 1, or anode and cathode expansion cells 232 and 234 shown in FIG. 2) may be configured to change a volumetric space of the apparatus and contain the fluid. In some examples, the volumetric space may be adjustable and configured to accommodate the volume of the fluid such that electrodes located within a base cell of the apparatus are substantially immersed in the fluid. In some embodiments, the apparatus may be configured to change the volumetric space of the apparatus by a volumetric space adjustor. The volumetric space adjustor may be configured to variably adjust the volumetric space of the apparatus. By way of example, but not imitation, the volumetric space adjustor may include one or more of a piston-type of pump and/or a plunger-type of pump. Block 710 may be followed by block 720, “ELECTRICALLY CONDUCTING THE FLUID VIA THE ELECTRODES TO PROVIDE THE ELECTROLYZED FLUID.”

At block 720, the apparatus (e.g., power supply 240 shown in FIG. 2) may be configured to electrically conducting the fluid via the electrodes to provide the electrolyzed fluid. In some embodiments, the apparatus may include a measuring device such as, for example, a pH meter and/or a sterilizing meter, and measure a pH level and/or an AC concentration of the fluid using the measuring device. In some embodiments, the apparatus may be configured to conducting electricity for a predetermined period of time to provide an electrolyzed fluid in a desired pH level and/or a desired AC concentration.

According to the above described method and other methods disclosed herein, electrolyzed fluid with a desired volume may be provided and utilized in domestic use as well as industrial use. In some examples, electrolyzed fluid may be used to sterilize food that should not be heated. For example, the electrolyzed fluid is used to sterilize vegetables, fruits and fish to prevent food poisoning involving, such as, norovirus, O-157, staphylococcus aureus, bacillus cereus, etc. In some other examples, the electrolyzed fluid may be used to sterilize cooking instruments, such as kitchen knives, cutting boards, dish towels, etc. In yet another example, the electrolyzed fluid may be used to prevent infection of human or animal bodies, instead of using alcohol.

In light of the present disclosure, one skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus configured to process a volume of a fluid and provide an electrolyzed fluid, the apparatus comprising:
a base cell configured to contain at least a portion of the volume of the fluid;
electrodes including an anode and a cathode, wherein the electrodes are mounted within the base cell; and
a variable expansion cell that is coupled to the base cell, wherein the variable expansion cell is adjustably configured to change a volumetric space of the apparatus to accommodate the volume of the fluid such that the electrodes are substantially immersed in the fluid.

2. The apparatus of claim 1, wherein the base cell includes a membrane, and
wherein the membrane is configured to divide the base cell into an anode portion and a cathode portion.

3. The apparatus of claim 2, the variable expansion cell comprising an anode-expansion cell and a cathode-expansion cell,
wherein the anode-expansion cell is coupled to the anode portion of the base cell, and
wherein the cathode-expansion cell is coupled to the cathode portion of the base cell.

4. The apparatus of claim 2, the membrane comprising at least one of a porous membrane or an ion-exchange membrane.

5. The apparatus of claim 1, wherein the base cell includes at least one fluid inlet formed on a surface of the base cell.

6. The apparatus of claim 1, wherein the base cell includes at least one fluid outlet configured to provide the electrolyzed fluid.

7. The apparatus of claim 6, wherein the at least one fluid outlet is formed on a surface of the base cell.

8. The apparatus of claim 1, wherein the base cell includes a parallelepiped-type cell including a substantially flat-shaped membrane.

9. The apparatus of claim 1, wherein the base cell includes a cylindrical-type cell including a substantially cylindrical-shaped membrane.

10. The apparatus of claim 1, wherein one or more of the base cell and/or the variable expansion cell are comprised of one or more of stainless steel and/or acrylic resin.

11. The apparatus of claim 1, the electrodes comprising one or more of mesh-type electrodes, plate-type electrodes, and/or rod-type electrodes.

12. The apparatus of claim 1, further comprising:
a power supply coupled to the electrodes and configured to effect electrical conduction through the fluid via the electrodes.

13. The apparatus of claim 1, wherein the variable expansion cell includes a volumetric space adjustor configured to variably adjust the volumetric space.

14. The apparatus of claim 13, the volumetric space adjustor comprising one or more of a piston-type of pump and/or a plunger-type of pump.

15. The apparatus of claim 1, the variable expansion cell comprising a cylindrical cell.

16. The apparatus of claim 1, the variable expansion cell comprising one or more of an anode-expansion cell and/or a cathode-expansion cell,
wherein the anode-expansion cell operably treats the fluid to contain an acidic-electrolyzed fluid, and
wherein the cathode-expansion cell operably treats the fluid to contain an alkaline-electrolyzed fluid.

17. The apparatus of claim 16, wherein capacities of the anode-expansion cell and the cathode-expansion cell are independently adjustable.

18. The apparatus of claim 1, further comprising:
a pH meter operably coupled to the base cell and configured to measure a pH level associated with the fluid.

19. The apparatus of claim 1, further comprising:
a sterilizing meter operably coupled to the base cell and configured to measure an available chlorine (AC) concentration associated with the fluid.

20. An apparatus configured to process a volume of a fluid and provide an electrolyzed fluid, the apparatus comprising:
a base cell configured to contain at least a portion of the fluid;
a membrane configured to divide the base cell into an anode portion and a cathode portion;
an anode mounted within the anode portion of the base cell;
a cathode mounted within the cathode portion of the base cell;
an anode expansion cell that is variably configured to provide a first additional space coupled to the anode portion of the base cell such that a capacity of the first additional space is adjustable; and
a cathode expansion cell that is variably configured to provide a second additional space coupled to the cathode portion of the base cell such that a capacity of the second additional space is adjustable.

21. The apparatus of claim 20, further comprising:
a first volumetric space adjustor configured to variably adjust the capacity of the first additional space; and
a second volumetric space adjustor configured to variably adjust the capacity of the second additional space.

22. The apparatus of claim 21, wherein each of the first and second volumetric space adjustors include one or more of a corresponding piston-type of pump and/or a plunger-type of pump.

23. A method to process a volume of a fluid and provide an electrolyzed fluid, the method comprising:
changing a volumetric space of an apparatus configured to contain the fluid, wherein the apparatus includes electrodes, and the volumetric space is adjustable and configured to accommodate the volume of the fluid such that the electrodes are substantially immersed in the fluid; and
electrically conducting the fluid via the electrodes to provide the electrolyzed fluid.

24. The method of claim 23, wherein the changing includes changing the volumetric space of the apparatus by a volumetric space adjustor, wherein the volumetric space adjustor configured to variably adjust the volumetric space of the apparatus.

25. The method of claim 24, the volumetric space adjustor comprising one or more of a piston-type of pump and/or a plunger-type of pump.

26. The method of claim 23, wherein the electrically conducting includes conducting electricity for a predetermined period of time to provide a electrolyzed fluid in a desired pH level and/or a desired available chlorine (AC) concentration.
